(19) United States
(12) Patent Application Publication
(10) Pub. No.: US 2025/0363813 A1
(43) Pub. Date: Nov. 27, 2025

(54) IMAGE PROCESSING APPARATUS, INFORMATION PROCESSING SYSTEM, INFORMATION PROCESSING METHOD, AND NON-TRANSITORY RECORDING MEDIUM

(71) Applicants: DENSO TEN Limited, Kobe, Hyogo (JP); AISIN CORPORATION, Kariya-shi, Aichi (JP)

(72) Inventors: Nobuaki KAJIMOTO, Kobe (JP); Masanori TORII, Kariya-shi (JP); Osamu KIMURA, Kariya-shi (JP)

(73) Assignees: DENSO TEN Limited, Kobe, Hyogo (JP); AISIN CORPORATION, Kariya-shi, Aichi (JP)

(21) Appl. No.: 19/208,736

(22) Filed: May 15, 2025

(30) Foreign Application Priority Data
May 22, 2024 (JP) 2024-083663

(51) Int. Cl. G06V 20/59

(52) U.S. Cl. CPC G06V 20/59

(57) ABSTRACT

An image processing apparatus is disclosed, which facilitates specifying a failed location when a failure occurs in displaying view images. The image processing apparatus processes view images from a plurality of in-vehicle cameras and outputs the processed view images to an in-vehicle information processing apparatus having a function of detecting stuck-states of the view images to be input. Controller circuitry of the image processing apparatus, when any of the plurality of in-vehicle cameras is determined to be faulty, determines any of a plurality of states defined by combinations of shift lever states of a vehicle and an installation location of the faulty in-vehicle camera. The controller circuitry instructs the in-vehicle information processing apparatus to disable the stuck-state detection function in the predetermined specific state among the plurality of states.

### CROSS REFERENCE TO THE RELATED APPLICATION

This application claims the benefit of Japanese Patent Application No. 2024-83663, filed on May 22, 2024, which is hereby incorporated by reference herein in its entirety.

### BACKGROUND

### Technical Field

The present disclosure relates to an image processing apparatus, an information processing system, an information processing method, and a non-transitory recording medium.

### Description of the Related Art

Conventionally, in an in-vehicle camera system, a failure diagnosis processor has been proposed to diagnose whether data line signals given from an imaging element unit are in a stuck state (refer to, e.g., Patent Document 1 given below). In this technology, image data acquired by the imaging element unit has a whole imaging area divided into an active (enabled) image region and an inactive (disabled) image region. The inactive image region contains a diagnostic data zone having stuck-state diagnostic data for diagnosing whether the data line signals are in a stuck state.
[Patent Document 1] International Publication No. WO2016/117401

### SUMMARY

Meanwhile, an image processing apparatus exemplified by Surround View Monitor (hereinafter abbreviated to SVM) is utilized, which composites view images being captured by cameras mounted on front, rear, left, and right sides of a vehicle, and displays the composited view images. In addition, an in-vehicle information processing apparatus called, e.g., In-Vehicle Infotainment (IVI) is utilized. When displaying the view images sent from the image processing apparatus on the information processing apparatus exemplified by IVI, problems arise in collaboration between the image processing apparatus and the in-vehicle information processing apparatus.

For example, the in-vehicle information processing apparatus may have a mechanism to detect a stuck state of the view image. Meanwhile, the image processing apparatus exemplified by SVM has a mechanism to detect that each physically-connected camera (indicating the wired-camera) is not yet logically-connected (indicating control logic OFF) or that the physically-connected camera is in a failure state. When the physically-connected camera is not yet logically-connected or is in the failure state, the image processing apparatus outputs, in place of the view image from the failure camera, for example, a single-color image (e.g., entirely blue).

As a result, a part of the SVM-based composited view images becomes the single-color image with no color change and is thus input to the in-vehicle information processing apparatus. This leads to a likelihood that the in-vehicle information processing apparatus might determine that the input view image has become stuck. The in-vehicle information processing apparatus, when determining that the input view image is stuck, outputs, as a fail-safe, for example, an entirely black image to a display screen, thereby notifying the vehicle's driver of the view image being stuck.

Thus, when the in-vehicle information processing apparatus outputs the entirely black image or other equivalent single-color images to the display screen, it is difficult to specify where the failure occurs. Specifically, it is hard to determine whether the image processing apparatus fails, in which camera connected to the image processing apparatus the failure occurs, and whether the failure is caused in the in-vehicle information processing apparatus.

An aspect of the embodiments disclosed herein enables an image processing apparatus that composites view images from a plurality of cameras and displays the composited view images, and an in-vehicle information processing apparatus that receives input of the view images from the image processing apparatus and displays the input view images, to facilitate specifying a failure element when the failure occurs in any of the cameras.

An aspect of the disclosed embodiment is exemplified by an image processing apparatus including controller circuitry. The image processing apparatus processes view images from a plurality of in-vehicle cameras, and outputs the processed view images to an in-vehicle information processing apparatus having a function of detecting a stuck-state of the view image to be input. When determining that any of the plurality of in-vehicle cameras is faulty, the controller circuitry determines any of a plurality of states defined by a combination of a state of a shift lever of a vehicle and an installing location of the faulty in-vehicle camera. The controller circuitry instructs the in-vehicle information processing apparatus to disable the stuck-state detection function in a predetermined specific state among the plurality of states.

The present image processing apparatus processes the view images from the plurality of in-vehicle cameras, and outputs the processed view images to the in-vehicle information processing apparatus having the function of detecting the stuck-state of the view image to be input. Herein, the in-vehicle information processing apparatus, upon detecting the stuck-state, sets the view images in a whole screen to a specific colored view image (e.g., black-colored view images) and outputs the specific colored view images. However, when a failure occurs in any of the plurality of in-vehicle cameras, and when the specific colored view images are displayed on the whole screen, it is difficult to determine which camera is faulty.

In the image processing apparatus and the in-vehicle information processing apparatus described above, when any of the plurality of in-vehicle cameras fails, an image stuck portion appears in the view images processed by the image processing apparatus and input to the information processing apparatus as the case may be. The image-stuck portion is not, however, dominant over the input view images, in which case there is such a likelihood that the in-vehicle information processing apparatus does not detect the stuck-state. On the other hand, when the image-stuck portion is dominant over the input view images, there is the high likelihood that the in-vehicle information processing apparatus detects the stuck-state.

Thus, a degree of how much the failure of any of the in-vehicle cameras affects the view images processed and input by the image processing apparatus, depends on a method by which the image processing apparatus processes the view images from the respective in-vehicle cameras. Normally, however, the method by which the image processing apparatus processes the view images from the respective in-vehicle cameras depends on states (positions) of a shift lever. This is because the view images desirable for being provided to a driver become different depending on the shift lever state (e.g., a shift position). Herein, the desirable view images depend on where the respective in-vehicle cameras are installed (for example, on a front side, a rear side, etc.) in the vehicle. Accordingly, the degree of how much the image-stuck portion affects the processed view images is specified to some extent corresponding to the plurality of states defined by combinations of the shift lever states of the vehicle and the installation location of the faulty in-vehicle camera.

The controller circuitry instructs the in-vehicle information processing apparatus to disable the stuck-state detection function in the predetermined specific state among the plurality of states. The disablement enables, when the likelihood is high that the in-vehicle information processing apparatus detects the stuck-state, inhibition of outputting the whole screen over which the view images are set in the specific color by restraining the stuck-state from being detected. As a result, the controller circuitry is enabled to facilitate specifying the failed location (failed camera), when the failure occurs in any of the in-vehicle cameras, in the image processing apparatus that composites the view images from the plurality of in-vehicle cameras and displays the composited view images, and in the in-vehicle information processing apparatus that inputs the view images from the image processing apparatus and displays these view images.

### BRIEF DESCRIPTION OF THE DRAWINGS

FIG. 1 is a diagram illustrating a configuration of an information processing system in one embodiment;

FIG. 2 is a diagram illustrating an image processing apparatus in detail;

FIG. 3 is a diagram illustrating an information processing apparatus in detail;

FIG. 4 is a table illustrating instructions of the image processing apparatus, which are notified to the information processing apparatus, corresponding to shift lever positions of a vehicle when failures occur in cameras;

FIGS. 5A to 5D are plan views illustrating example screens of front views displayed on a display of the information processing apparatus;

FIGS. 6A and 6B are plan views illustrating example screens of rear views displayed on the display of the information processing apparatus;

FIG. 7 is a flowchart illustrating processes of the image processing apparatus; and

FIG. 8 is a flowchart illustrating processes of the information processing apparatus.

### DESCRIPTION OF THE EMBODIMENT

Referring to the accompanying drawings, a detailed description will hereinafter be provided of an information processing system 100, which includes an image processing apparatus 1 and an information processing apparatus 2; an information processing method executed by the image processing apparatus 1; and a computer readable non-transitory recording medium storing a computer program (hereinafter referred to as “the program”) according to one embodiment.

### <Configuration>

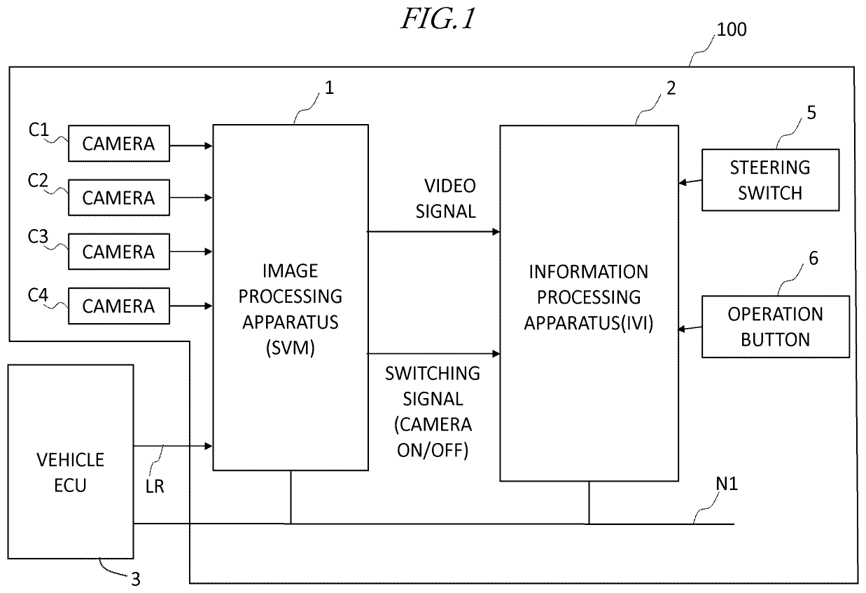

FIG. 1 is a diagram illustrating a configuration of the information processing system 100 of the embodiment. The information processing system 100 is installed in, e.g., a vehicle to provide vehicle's occupants (hereinafter also referred to as users) with entertainment functions through audio, video and other equivalent information, and with driving assistance functions exemplified by navigation.

The information processing system 100 includes cameras C1 through C4, the image processing apparatus 1 to which the cameras C1 through C4 are connected, and an information processing apparatus 2 cooperating with the image processing apparatus 1. Note that the information processing apparatus 2 is provided with a steering switch 5 and an operation unit containing operation buttons 6, which accept operations from the users.

A vehicle ECU (Electric Controller) 3 is connected to the image processing apparatus 1 and the information processing apparatus 2 in FIG. 1. The vehicle ECU 3 is connected via an in-vehicle network N1 to the image processing apparatus 1 and the information processing apparatus 2. The network N1 is defined as an in-vehicle LAN (Local Area Network) exemplified by CAN (Controller Area Network) and FLEXRAY (registered trademark). In FIG. 1, the vehicle ECU 3 is connected via a signal line LR to the image processing apparatus 1. The signal line LR is a signal line connected via an Input/Output interface exemplified by GPIO (General Purpose Input/Output). The signal line LR may also, however, be a signal line for serial communications, which is exemplified by SPI (Serial Peripheral Interface and I2C (Inter-Integrated Circuit).

The image processing apparatus 1 has a function called a Surround View system (SVM (Surround View Monitor) system)). The Surround View system is also called an Around View system (AVM (Around View Monitor) system)). For example, the camera C1 is an imaging device that captures a view image of a front side of the vehicle; the camera C2 captures a view image of a right side of the vehicle; the camera C3 captures a view image of a rear side of the vehicle; and the camera C4 captures a view image of a left side of the vehicle. The cameras C1 through C4 are called a front camera, a right camera, a rear camera, and a left camera, respectively. The cameras C1 through C4 are one example of a plurality of in-vehicle cameras.

The cameras C1 through C4 input, to the image processing apparatus 1, view image (video) signals conforming to protocols exemplified by GMSL (Gigabit Multimedia Serial Link), LVDS (Low Voltage Differential Signaling), GVIF (Gigabit Video InterFace), and FPD-Link (Flat Panel Display Link). The SVM composites, based on the view images from the cameras C1 through C4, view images with the vehicle being viewed, e.g., in plane from above, and inputs the composited view images as video signals to the information processing apparatus 2. The video signals input to the information processing apparatus 2 are also signals conforming to the protocols exemplified by GMSL, LVDS, GVIF, and FPD-Link, etc.

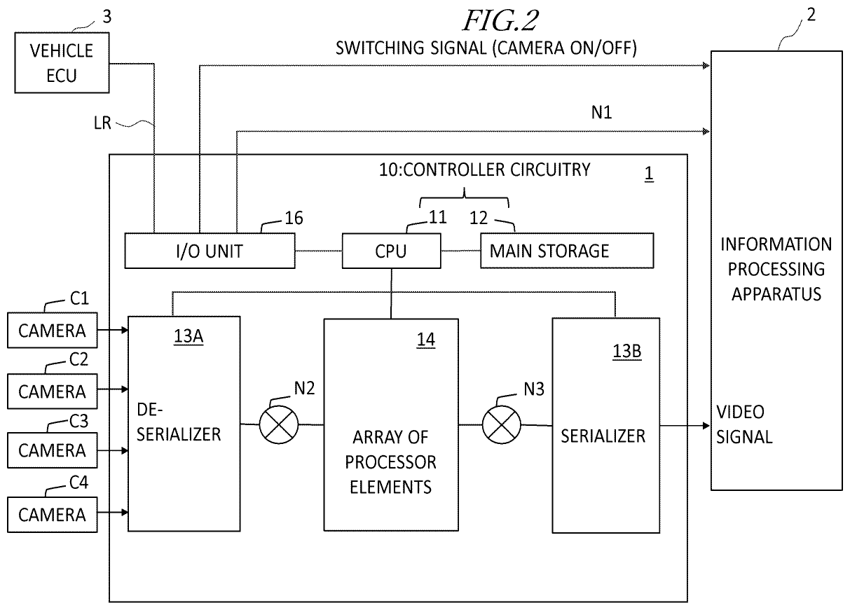

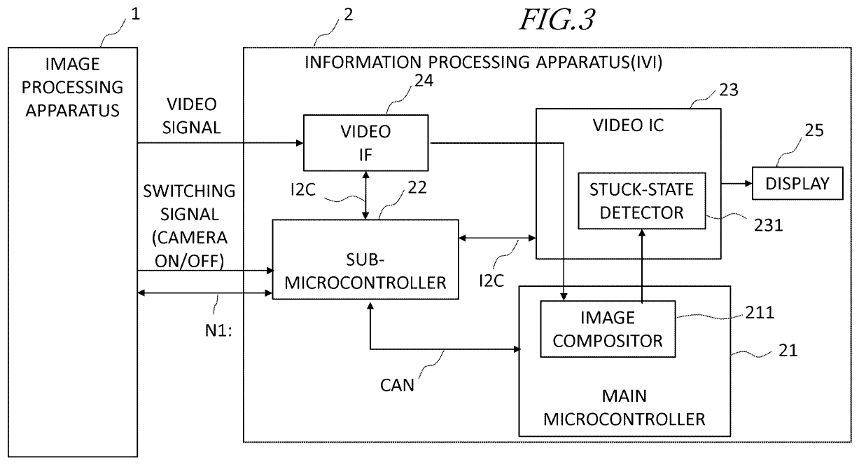

The image processing apparatus 1 transmits, to the information processing apparatus 2, a switching signal for switching a screen that is output by the information processing apparatus 2 to a display 25 (see FIG. 3). The switching signal is used for outputting the view images, containing the SVM-based composited view images, from the cameras C1 through C4 to the display 25, or for switching to a display screen other than the view images from the cameras C1 through C4. An in-depth description of the switching signal will be provided in FIG. 2.

The image processing apparatus 1 receives, via the signal line LR a reverse signal indicating that the shift lever is set to a backward traveling position (reverse position), from the vehicle ECU 3. The image processing apparatus 1 further receives signals, containing the reverse signal, indicating the respective positions of the shift lever of the vehicle, from the vehicle ECU 3 via the network N1. For example, the image processing apparatus 1, upon receiving, via the signal line LR, the reverse signal indicating that the shift lever is set to the reverse position, instructs the information processing apparatus 2 to output the view images from the cameras C1 through C4 to the display 25 (see FIG. 3) by the switching signal. The view images contain the SVM-based composited view images. Note that the information processing apparatus 2 may also output, to the display 25, a back monitor view image captured by the camera C3 that captures a backward view image of the vehicle in place of the SVM-based composited view images.

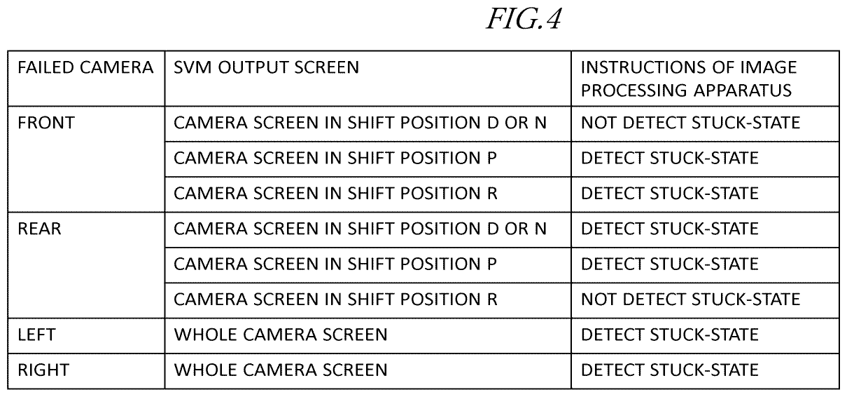

In the embodiment, the image processing apparatus 1 executes different processes corresponding to the positions of the shift lever of the vehicle when any of cameras C1 through C4 fails. The different processes corresponding to the positions of the shift lever will be explained with reference to FIG. 4.

The information processing apparatus 2 is one example of an in-vehicle information processing apparatus, and is also known as In-Vehicle Infotainment (IVI), Display Audio (DA), or Head Unit (H/U). Specifically, the information processing apparatus 2 may be configured to have, for example, audio/visual/navigation functions. However, this does not mean that the information processing apparatus 2 is limited to the in-vehicle information processing apparatus described above.

The steering switch 5 and the operation buttons 6 are user interfaces to accept, from the user, a switching instruction for a display content on the display 25 by the information processing apparatus 2. When the steering switch 5 is operated, the information processing apparatus 2 displays, on the display 25, the composited view images from the image processing apparatus 1. When the operation buttons 6 are operated during display of the composited view images from the image processing apparatus 1 on the display 25, the information processing apparatus 2 outputs other display screens on the display 25 instead of displaying the composited view images from the image processing apparatus 1. The other display screens include, for example, a TV broadcasting screen, a screen for operating the audio function, and a car navigation screen.

Note that when the steering switch 5 and the operation buttons 6 are operated the information processing apparatus 2 notifies the image processing apparatus 1 of the acceptance of these operations via the network N1. In response, the image processing apparatus 1 instructs the information processing apparatus 2, by the switching signal (camera ON/OFF), to output the screens corresponding to the operations of the steering switch 5 and the operation buttons 6 to the display 25.

The information processing apparatus 2, connected to the vehicle ECU 3 via the network N1, collects pieces of information of the vehicle conditions from the vehicle ECU 3. The vehicle conditions are exemplified by the position of the shift lever, a speed, an acceleration, and a steering angle.

FIG. 2 is a diagram illustrating the image processing apparatus 1 in detail. Note that the cameras C1 through C4, the information processing apparatus 2 and the vehicle ECU 3 are illustrated together in FIG. 2. The image processing apparatus 1 includes a Central Processor (hereinafter abbreviated to CPU) 11, a main storage 12, a de-serializer 13A, a serializer 13B, an Array of Processor Elements 14, and an I/O unit 16.

The de-serializer 13A converts, into parallel signals, the view image signals (video signals) based on GMSL and other protocols, which are input through serial communications from the cameras C1 through C4, and hands over the parallel signals to the Array of Processor Elements 14. The serializer 13B stores view image data (video data for, e.g., one line) processed by the Array of Processor Elements 14, then converts the video data into serial video signals, and supplies the serial video signals to the information processing apparatus 2.

Each of the processor elements within the Array of Processor Elements 14 includes a plurality of arithmetic units that execute multiple operations exemplified by addition, comparison, product, and sum of products. Each processor element executes pipeline processing, and concurrently executes parallel image processing for frames input to the image processing apparatus 1 by the plurality of arithmetic units. It should be noted that the image processing apparatus 1 may have a single processor or a plurality of processors (for example, Digital Signal Processor (DSP)) in place of the Array of Processor Elements 14.

The de-serializer 13A is connected via a network N2 to the Array of Processor Elements 14. The Array of Processor Elements 14 is connected via a network N3 to the serializer 13B. Note that the networks N2 and N3 may also be integrated. The networks N2 and N3 may be configured to include, for instance, a cross-bar switch or other equivalents. The networks N2 and N3 enable parallel accesses to the de-serializer 13A and the serializer 13B from the Array of Processor Elements 14, and enable parallel data transfer between the processor elements.

The CPU 11 executes a computer program deployed in an executable manner on the main storage 12, thereby controlling the respective units of the image processing apparatus 1. Specifically, the CPU 11 executes parallelization of the video signals input from the cameras C1 through C4 by the de-serializer 13A, and executes start of the image processing by the Array of Processor Elements 14. The image processing herein involves generating the SVM-based composited view images. The CPU 11 controls the serializer 13B to serialize the composited view images that are image-processed by the Array of Processor Elements 14. The CPU 11 is also called a processor. However, this does not mean that the CPU 11 is limited to the single processor, and the CPU 11 may also take a multi-processor configuration.

The main storage 12 is simply called a memory, and stores the computer program to be executed by the CPU 11 and the data to be processed by the CPU 11. The main storage 12 is exemplified by Dynamic Random Access Memory (DRAM), Static Random Access Memory (SRAM), and Read Only Memory (ROM). Note that the CPU 11 and the main storage 12 can be said to be a controller circuitry (hereinafter simply referred to as controller) 10. The controller 10 is one example of the controller circuitry.

The I/O unit 16 is an interface for performing communications with, for example, the information processing apparatus 2, the vehicle ECU 3 and other equivalent equipment outside of the image processing apparatus 1. The I/O unit 16 is, as already stated, for instance, the GPIO interface. However, the I/O unit 16 may also be an interface to a serial bus or an equivalent for SPI and I2C. In the embodiment, the image processing apparatus 1 transmits, to the information processing apparatus 2 via the I/O unit 16, a signal for instructing switching of the screen to be output to the display 25 (see FIG. 3). The switchover of the screen involves switching between the display of the SVM-based composited view images and the display of the screen other than the composited view images.

The I/O unit 16 may include an interface of the signal line LR connected to the vehicle ECU 3. The I/O unit 16 may further include an interface to the network N1. The computer program to be executed by the CPU 11 may also be loaded onto the main storage 12 from an external apparatus via, e.g., the I/O unit 16.

FIG. 3 is a diagram illustrating the information processing apparatus 2 in detail. Note that the image processing apparatus 1 is illustrated together in FIG. 3. The information processing apparatus 2 includes a main microcontroller 21, a sub-microcontroller 22, a video IC 23, a video interface (hereinafter abbreviated to video IF) 24, and the display 25.

The main microcontroller 21 is a device known as System on a Chip (SoC), in which a plurality of elements are installed on one chip. The main microcontroller 21 includes, for instance, a CPU (Central Processor) and a memory. The CPU executes a computer program deployed in the executable manner on the memory, thereby providing functions as the main microcontroller 21. This does not mean that the CPU is limited to the single processor, and the CPU may take a multi-processor configuration. The main microcontroller 21 may include a GPU (Graphical Processor), a DSP (Digital Signal Processor), and other equivalent devices.

The memory stores the computer program to be executed by the CPU and the data to be processed by the CPU. The memory is exemplified by Dynamic Random Access Memory (DRAM), Static Random Access Memory (SRAM), and Read Only Memory (ROM).

The main microcontroller 21 includes a view image compositor 211 as a module having a CPU and a memory on which to deploy a program in the executable manner. The view image compositor 211 generates overlap images by overlapping informative images on the view images (videos) to be input from the image processing apparatus 1 via the video IF 24 and the video IC 23, and feeds back the generated overlap images to the video IC 23. The view images to be input from the image processing apparatus 1 are, for example, the SVM-based composited view images, the view images on the back monitor that captures the views on the rear side of the vehicle, and other equivalent images. The overlap images are the view images obtained by overlapping, for example, the informative images of added information for the driver assistance and other equivalents on the view images input from the image processing apparatus 1.

The added information is exemplified by objects of the view images or components within angles of views that are input from the image processing apparatus 1, and guide lines indicating positional relationships with the vehicle equipped with the information processing apparatus 2. The guide lines are previously stored as image data in the memory of, for instance, the main microcontroller 21. The added information may also be graphic objects, character strings and other equivalents for attracting an attention of the driver.

The main microcontroller 21 is connected to the sub-microcontroller 22 through serial communications on CAN or other equivalent networks. The main microcontroller 21 receives the switching signals (ON/OFF signals of camera) from the image processing apparatus 1 via the sub-microcontroller 22. The main microcontroller 21 accesses the network N1 via the sub-microcontroller 22, thereby communicating with the image processing apparatus 1 and the vehicle ECU 3.

The video IC 23 has components similar to the components of the image processing apparatus 1 in FIG. 2. The video IC 23 includes, for example, the CPU, the memory, the Array of Processor Elements, and the I/O unit. The CPU controls the Array of Processor Elements by executing the computer program stored in the memory, thereby providing functions of the video IC 23. The video IC 23 receives the video signals of the SVM-based composited view images from the image processing apparatus 1, decodes the received video signals, and converts the decoded video signals into videos of a format displayable on the display 25.

In a normal state indicating no detection of abnormality exemplified by the stuck state and other equivalent state, the video IC 23 hands over the displayable-formatted videos to the view image compositor 211 mounted on the main microcontroller 21, whereby the overlap images are obtained from the view image compositor 211. The video IC 23 outputs the obtained overlap images to the display 25, thereby displaying the overlap images on the display 25.

In the embodiment, the video IC 23 includes a stuck-state detector 231. The stuck-state detector 231 detects the abnormalities in the main microcontroller 21 and other equivalent components. Specifically, the stuck-state detector 231 detects the stuck-state by determining whether the overlap images (videos) transmitted from the view image compositor 211 of the main microcontroller 21 are the stuck images. The stuck images remain the same without any changes of the respective frames that form the view images. The stuck-state detector 231 implements a fail-safe process just when detecting that the view images are stuck. The fail-safe process is a process of outputting, e.g., the black images to the entire screen of the display 25. With the black images, the video IC 23 causes the user to recognize that the main microcontroller 21 fails.

The sub-microcontroller 22 includes a plurality of I/O interfaces, thereby providing communication functions with the external devices of the information processing apparatus 2. The sub-microcontroller 22 includes an interface for receiving, e.g., the switching signal (ON/OFF signal of the camera). The sub-microcontroller 22 is connected to both the video IC 23 and the video IF 24 through the serial communications based on I2C and SPI. In addition, the sub-microcontroller 22 includes an interface connected to the network N1.

The video IF 24 is an interface for receiving video signals from the image processing apparatus 1. The video IF 24 receives signals conforming to the protocols exemplified by GMSL, LVDS, GVIF and FPD-Link. The display 25 outputs video information and other equivalent information transmitted from the video IC 23. The display 25 is exemplified by a Liquid Crystal Display (LCD), an Electroluminescence Panel, and an Organic Light Emitting Diode (OLED).

### (Control Example of Screen Display)

FIG. 4 is a table illustrating instructions from the image processing apparatus 1, which are notified to the information processing apparatus 2, corresponding to the shift lever positions of the vehicle when failures occur in the cameras C1 through C4. The table in FIG. 4 exemplifies relationships between the failed cameras C1 through C4 (failed cameras), the output screens based on the positions of the shift lever when the failures are caused in the cameras, provided by the information processing apparatus 2 (SVM), and the instructions notified to the information processing apparatus 2 from the image processing apparatus 1. In the embodiment, as already stated, it is assumed that the camera C1 is the front camera, the camera C2 is the right camera, the camera 3 is the rear camera, and the camera C4 is the left camera.

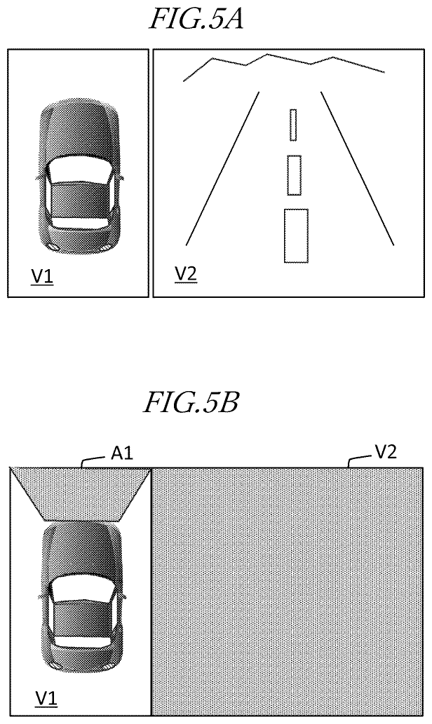

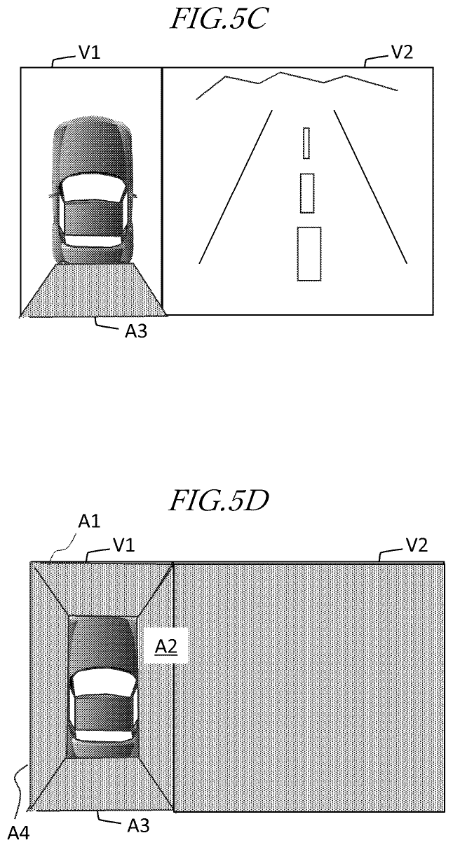

When the failed camera is, for example, the front camera C1, and when the shift lever is in a D (drive, forward traveling) position or an N (neutral) position, the image processing apparatus 1 notifies the information processing apparatus 2 of an instruction “Not Detect Stuck-State”. When the shift lever is in the D or N position, in the SVM images generated by the image processing apparatus 1, a front view from the front camera C1 occupies most of the screen and is displayed on the display 25 (see FIGS. 5A and 5B). As illustrated in FIG. 5A, the SVM screen displays both of an overall view (V1) of vehicle peripheries viewed in plane from above, and a camera view (V2) of the view image captured in a specific direction (e.g., the front direction of the vehicle by the front camera C1). A proportion of the camera view (V2) of the specific direction on the screen is larger than a proportion of the overall view (V1).

On the screen described above, when the front camera C1 fails, the image processing apparatus 1 sets the view images from the front camera C1 to a single color (e.g., entirely blue color) and outputs the blue-colored view images. As a result, the single-colored view images become dominant on the SVM screen. In response, the information processing apparatus 2 has a high likelihood of setting the view images to black on the whole screen of the display 25 due to determining that the view images from the image processing apparatus 1 are stuck.

In this case, when the information processing apparatus 2 does not detect the stuck-state in accordance with the instruction, the view images input from the image processing apparatus 1 are displayed in an as-is state on the display 25. Consequently, these as-is view images facilitate user's determining which camera among the cameras C1 through C4 fails. In FIG. 4, a plurality of states are given in each row, which are defined by combinations of the states (positions) of the shift lever of the vehicle and the installation locations of the failed cameras C1 through C4. In FIG. 4, the front camera C1 fails, and the shift lever is in the D or N position, in which case this state is one example of a predetermined specific state among the plurality of states. When the failed camera is the front camera C1 and

the shift lever is in the P (Parking) position, the image processing apparatus 1 notifies the information processing apparatus 2 of an instruction “Detect Stuck-State”. When the shift lever is in the P position, side views are displayed on the display 25, in which right-and-left view images in the vehicle forward traveling direction occupy majority portions of the screens other than the front view screen in the SVM-view images generated by the image processing apparatus 1. In this case, when the front camera C1 fails, and even when the image processing apparatus 1 sets the view image from the front camera C1 to the single color (e.g., entirely blue color) and outputs the blue-colored view image, a proportion that the single-colored view image occupies the screens is small. Hence, the likelihood is low that the information processing apparatus 2 determines the view images input from the information processing apparatus 2 to be stuck. Accordingly, the information processing apparatus 2 is notified of the instruction “Detect Stuck-State”.

Similarly when the failed camera is the front camera C1 and the shift lever is in the R (Reverse, backward traveling) position, the image processing apparatus 1 notifies the information processing apparatus 2 of the instruction “Detect Stuck-State”. When the shift lever is in the R position, the rear view is displayed on the display 25, in which a rear view image of the vehicle occupies the majority portions of the screens in the SVM-view images generated by the image processing apparatus 1. Similarly to when the shift lever is in the P (Parking) position, the likelihood is therefore low that the information processing apparatus 2 determines the view images input from the information processing apparatus 2 to be stuck. Accordingly, the information processing apparatus 2 is notified of the instruction “Detect Stuck-State”.

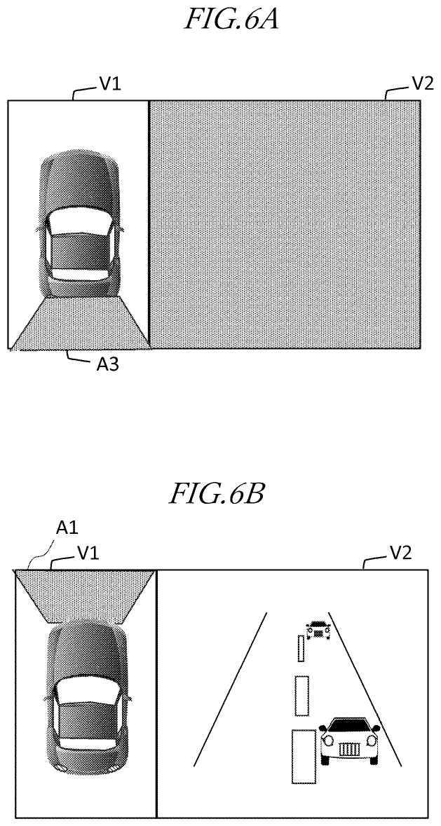

When the failed camera is, e.g., the rear camera C3 and the shift lever is in the R (Reverse, backward traveling), the information processing apparatus 2 notifies the information processing apparatus 2 of the instruction “Not Detect Stuck-State”. When the shift lever is in the R position, the rear view is displayed on the display 25 (see FIGS. 6(A), (B)), in which the view image from the rear camera C3 occupies the majority portions of the screens in the SVM-view images generated by the image processing apparatus 1. When the rear camera C3 fails, the image processing apparatus 1 sets the view image from the rear camera C3 to the single color (e.g., entirely blue color) and outputs the single-colored view image. In response, a likelihood is high that the image processing apparatus 1 determines the view images input from the image processing apparatus 1 to be stuck, and sets the whole screens on the display 25 to black view images. Accordingly, the information processing apparatus 2 is notified of the instruction “Not Detect Stuck-State”. In FIG. 4, the rear camera C3 fails, and the shift lever is in the R position, in which case this state is one example of the predetermined specific state among the plurality of states defined by the combinations of the shift lever states of the vehicle and the installation locations of the faulty in-vehicle cameras.

However, when the failed camera is the rear camera C3 and the shift lever is in the D, N or P position, the image processing apparatus 1 notifies the information processing apparatus 2 of the instruction “Detect Stuck-State”. In this case, when the rear camera C3 fails, and even when the image processing apparatus 1 sets the view image from the rear camera C3 to the single color (e.g., entirely blue color) and outputs the single-colored view image, a proportion of the single-colored view image occupying the screen is low. Therefore, the likelihood is low that the information processing apparatus 2 determines the view images input from the image processing apparatus 1 to be stuck. Accordingly, the information processing apparatus 2 is notified of the instruction “Detect Stuck-State”.

Similarly, when the failed camera is the right camera C2 or the left camera C4, regardless of the shift lever position, the proportion of the single-colored (e.g., entirely blue-colored) view image occupying the screen is low. For instance, when the shift lever is in the P (Parking) position, the side views are displayed on the display 25, in which the right-and-left view images in the vehicle forward traveling direction occupy the majority portions of the screens other than the front view screen in the SVM-view images generated by the image processing apparatus 1. However, even when one of the right camera C2 and the left camera C4 fails, the proportion of the single-colored view image occupying the screen is not large. Such being the case, the failed camera is the right camera C2 or the left camera C4, in which case the image processing apparatus 1 notifies the information processing apparatus 2 of the instruction “Detect Stuck-State” irrespective of the shift lever position. To be specific, in FIGS. 5A to 5D, when the failed camera is the right camera C2 or the left camera C4, the image processing apparatus 1 notifies the information processing apparatus 2 of the instruction “Detect Stuck-State” on the whole camera screens.

FIGS. 5A to 5D illustrate examples of the front view screens displayed on the display 25 of the information processing apparatus 2. Specifically, FIGS. 5A to 5D illustrate the examples of the screens when the shift lever is in the D (Drive, forward traveling) position or the N (Neutral) position.

FIG. 5A illustrates the SVM screens, output to the display 25, by the image processing apparatus 1 and the information processing apparatus 2 when no failures occur in any of the cameras C1 through C4. In this example, the SVM screens are a combination of a whole view (V1) indicating the periphery of the vehicle and a camera view (V2) in the specific direction. The camera view (V2) in the specific direction is larger than the whole view (V1), and occupies approximately two thirds (⅔) of the SVM screen. In FIG. 5A the shift lever is in the D or N position, and the camera view (V2) in the specific direction is the front view of the view image captured in the front direction of the vehicle.

FIG. 5B illustrates the SVM screens when the front camera (C1) fails in FIG. 5A. In this case, the image processing apparatus 1 disposes the single-colored (e.g., entirely blue-colored) view image over a front area A1 of the vehicle in the whole view (V1) displaying the periphery of the vehicle and the single-colored view image over the front view (camera view V2), and outputs the thus-arranged screens to the information processing apparatus 2. Note that the normal view images are obtained from the rear camera C3, the right camera C2 and the left camera C4. In this case, the information processing apparatus 2 does not detect the stuck state in accordance with FIG. 4. Consequently, the information processing apparatus 2 outputs the as-is SVM-images (FIG. 5B) input from the image processing apparatus 1 to the display 25. Note that the single color (e.g., entirely blue color) is represented by hatching in FIGS. 5 and 6.

FIG. 5C illustrates the SVM-images when the rear camera C3 fails. In this case, the image processing apparatus 1 disposes the single-colored (e.g., entirely blue-colored) view image over a rear area A3 of the vehicle in the whole view (V1) displaying the periphery of the vehicle, and outputs the thus-arranged screen to the information processing apparatus 2. Note that the front camera C1, the right camera C2 and the left camera C4 output the normal view images.

In this case, the view image is output to the front view screen (camera view V2) from the normal front camera C1. Therefore, the proportion of the single-colored view image occupying the whole SVM-view images is not large. Accordingly, the likelihood is low that the information processing apparatus 2 mistakenly determines the view image to be stuck, despite performing the stuck-state detection in accordance with FIG. 4. Hence, the information processing apparatus 2 outputs the as-is SVM-view images (FIG. 5C) input from the image processing apparatus 1 to the display 25.

FIG. 5D illustrates the SVM screen when all the cameras C1 through C4 fail in FIG. 5A. In this case, the image processing apparatus 1 outputs, to the information processing apparatus 2, the single-colored view images (e.g., entirely blue colored image) in entire areas A1 through A4 of the whole view (V1) representing the periphery of the vehicle. Due to the failure of the front camera C1, the single-colored view image (e.g., entirely blue colored image) is also disposed in the front view (camera view V2), and the thus-arranged front view is output to the information processing apparatus 2. In this case, the information processing apparatus 2 does not detect the stuck-state in accordance with FIG. 4. Accordingly, the information processing apparatus 2 outputs the as-is SVM-view images (FIG. 5D) input from the image processing apparatus 1 to the display 25.

FIGS. 6A and 6B illustrate examples of the rear view screen displayed on the display 25 of the information processing apparatus 2. Specifically, FIGS. 6A and 6B illustrate the screen example when the shift lever is in the R (Reverse, backward traveling) position.

FIG. 6A illustrates the SVM screen of the rear view when the rear camera C3 fails. In this instance, the image processing apparatus 1 disposes the single-colored view image (e.g., entirely blue-colored image) over the rear area A3 of the vehicle in the whole view (V1) representing the periphery of the vehicle and over the rear view (camera view V2), and outputs the thus-arranged view images to the information processing apparatus 2. Then, the normal view images are obtained from the front camera C1, the right camera C2, and the left camera C4. In this case, the information processing apparatus 2 does not detect the stuck-state in accordance with FIG. 4. Accordingly, the information processing apparatus 2 outputs the as-is SVM-view images (FIG. 6A) input from the image processing apparatus 1 to the display 25.

FIG. 6B illustrates the SVM screen when not the rear camera C3 but the front camera C1 fails in FIG. 6A. In this case, the image processing apparatus 1 disposes the single-colored view image (e.g., entirely blue colored image) over the front area A1 of the vehicle in the whole view (V1) representing the periphery of the vehicle, and outputs the thus-arranged view images to the information processing apparatus 2. Then, the normal view images are obtained from the right camera C2, the rear camera C3, and the left camera C4. However, the view image is output from the non-failed rear camera C3 to the rear view (camera view V2). Accordingly, the proportion of the single-colored view image occupying the whole SVM-view images is not large. Therefore, the likelihood is low that the information processing apparatus 2 mistakenly determines the view image to be stuck, despite performing the stuck-state detection in accordance with FIG. 4. Hence, the information processing apparatus 2 outputs the as-is SVM-view images (FIG. 6B) input from the image processing apparatus 1 to the display 25.

### (Processing Procedures)

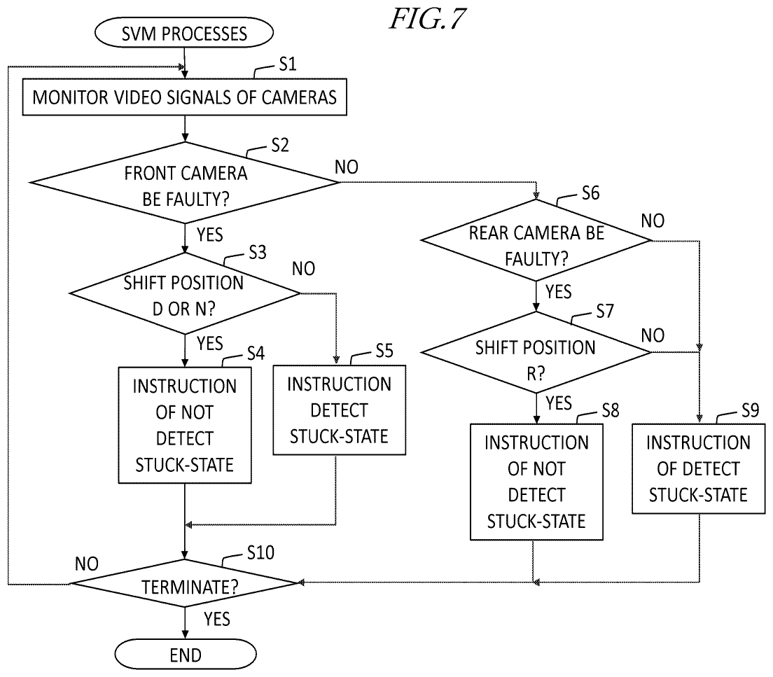

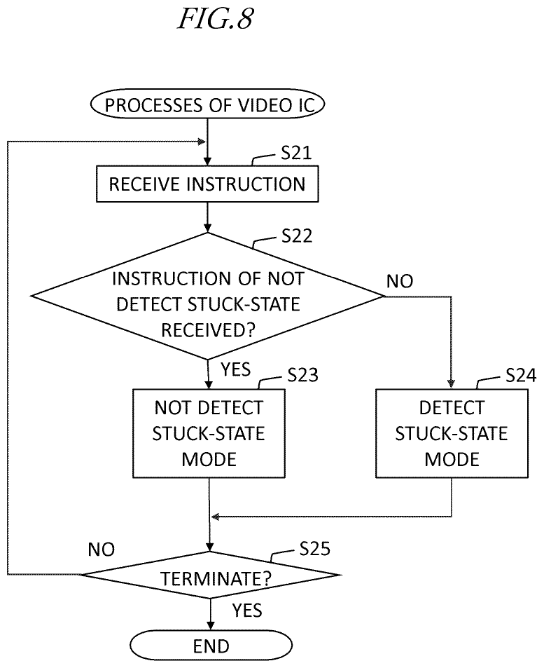

FIG. 7 is a flowchart illustrating processes (called as SVM process) of the image processing apparatus 1. The controller 10 of the image processing apparatus 1 executes the processes in FIG. 7 as one example of controller circuitry. The image processing apparatus 1 starts executing the processes in FIG. 7 upon being triggered by, e.g., accessory power-on of the vehicle. The image processing apparatus 1 may also start executing the processes in FIG. 7 upon power-on of the information processing apparatus 2. The image processing apparatus 1 may further start executing the processes in FIG. 7 upon the start of a driving assistance process (e.g., FIG. 8) by the information processing apparatus 2.

In the SVM process, the image processing apparatus 1 monitors the video signals of the respective cameras C1 through C4 (S1). The image processing apparatus 1 determines whether the front camera C1 is faulty (S2). When the front camera C1 is faulty, the image processing apparatus 1 sets the view image from the front camera C1 to the single-colored view image (e.g., entirely blue colored image). The image processing apparatus 1 generates the composite SVM-view images from the single-colored view image and the view images given from the other cameras C2 through C4, and provides the composite SVM-view images to the information processing apparatus 2.

The image processing apparatus 1 determines whether the shift lever is in the D or N position (S3). When the front camera C1 is determined to be faulty in S2, and when the shift lever is determined to be in the D or N position in S3, this state is one example of the predetermined specific state among the plurality of states defined by the combinations of the shift lever states of the vehicle and the installation locations of the faulty in-vehicle cameras. When the shift lever is in the D or N position, the image processing apparatus 1 notifies the information processing apparatus 2 of the instruction “Not Detect Stuck-State” (S4). The process in S4 is one example of instructing the information processing apparatus 2 to disable a stuck-state detection function. On the other hand, when the shift lever is in the position other than any of “D” and “N”, the image processing apparatus 1 notifies the information processing apparatus 2 of the instruction “Detect Stuck-State” (S5).

When the front camera C1 is determined not to be faulty in S2, the image processing apparatus 1 determines whether the rear camera C3 is faulty (S6). When the rear camera C3 is faulty, the image processing apparatus 1 sets the view image from the rear camera C3 to the single-colored view image. The image processing apparatus 1 generates the composite SVM-view images from the single-colored view image and the view images from the other cameras C1, C2 and C4, and provides the composite SVM-view images to the information processing apparatus 2.

Subsequently, the image processing apparatus 1 determines whether the shift lever is in the R position (S7). When the rear camera C3 is determined to be faulty in S6, and when the shift lever is determined to be in the R position in S7, this state is one example of the predetermined specific state among the plurality of states defined by the combinations of the shift lever states of the vehicle and the installation locations of the faulty in-vehicle cameras. When the shift lever is in the R position, the image processing apparatus 1 notifies the information processing apparatus 2 of the instruction “Not Detect Stuck-State” (S8). The process in S8 is one example of instructing the information processing apparatus 2 to disable the stuck-state detection function. On the other hand, when the shift lever is in the position other than “R”, the image processing apparatus 1 notifies the information processing apparatus 2 of the instruction “Detect Stuck-State” (S9).

Then, the information processing apparatus 2 determines whether to terminate processing (S10). For example, when the accessory power of the vehicle is switched off, the image processing apparatus 1 terminates the processes in FIG. 7. When the power of the information processing apparatus 2 is switched off, the information processing apparatus 2 may terminate the processes in FIG. 7. Whereas when not terminating the processes, the image processing apparatus 1 repeats processing from S1.

FIG. 8 is a flowchart illustrating the processes of the information processing apparatus 2. The processes in FIG. 8 are included in, e.g., the driving assistance process. The main microcontroller 21 of the information processing apparatus 2 starts the driving assistance process when, e.g., the accessory power of the vehicle is switched on. However, the information processing apparatus 2 may also start the driving assistance process, for instance, when the steering switch 5 is operated and when the shift lever of the vehicle is shifted to the “R” position.

In this process (video IC process), the information processing apparatus 2 receives the instruction from the image processing apparatus 1 (S21). The information processing apparatus 2 determines whether to receive the instruction “Not Detect Stuck-State” (S22). The information processing apparatus 2, when receiving the instruction “Not Detect Stuck-State”, executes the driving assistance process in a “Not Detect Stuck-State” mode (S23). In this case, the information processing apparatus 2 outputs, to the display 25, the as-is view images provided from the image processing apparatus 1 without detecting the stuck-state.

On the other hand, when the instruction “Not Detect Stuck-State” is not received, the information processing apparatus 2 executes the driving assistance process in a “Detect Stuck-State” mode (S24). In this case, the information processing apparatus 2 detects the stuck-state of the view images provided from the image processing apparatus 1. Therefore, when the screen-stuck areas are dominant over the view images as in FIGS. 5(B), 5(D) and 6(A), the information processing apparatus 2 determines the view images provided from the image processing apparatus 1 to be stuck. Consequently, the image processing apparatus 1 outputs the black view images to the display 25.

The information processing apparatus 2 determines whether the processing is terminated (S25). The information processing apparatus 2 terminates the processes in FIG. 8 when the accessory power of the vehicle is switched off. The information processing apparatus 2, when the processing is not terminated, iterates the processes from S21.

### Effects of Embodiment

As discussed above, in the embodiment, the image processing apparatus 1 executes the following processes when any of the plurality of in-vehicle cameras C1 through C4 is determined to be faulty. To be specific, the image processing apparatus 1 instructs the information processing apparatus 2 to disable the function of detecting the stuck-state in the predetermined specific state among the plurality of states defined by the combinations of the shift lever states of the vehicle and the installation locations of the faulty camera C1 and other cameras.

Accordingly, for example, as in FIGS. 5(B), 5(D) and 6(A), even when the image-stuck areas become dominant over the SVM view images (videos) provided from the image processing apparatus 1, the information processing apparatus 2 does not output the black view images. Namely, the information processing apparatus 2 outputs, to the display 25, the as-is SVM-view images provided from the image processing apparatus 1. Hence, when the failures occur in the plurality of cameras C1 through C4, the image processing apparatus 1 enables the user to easily specify the faulty camera in the displayed SVM-view images obtained by compositing the videos (view images) given by the plurality of cameras C1 through C4.

When the shift lever of the vehicle is in the D (forward traveling) or N (neutral) position, and when the failure occurs in the front camera C1 that captures the front view image of the vehicle, the image processing apparatus 1 instructs the in-vehicle information processing apparatus 2 to disable the function of detecting the stuck-state. Accordingly, the image processing apparatus 1 enables the user to easily specify where the failure occurs when the front camera C1 fails.

When the shift lever of the vehicle is in the R (Reverse, backward traveling) position, and when the failure occurs in the rear camera C3 that captures the rear of the vehicle, the image processing apparatus 1 instructs the in-vehicle information processing apparatus 2 to disable the function of detecting the stuck-state. Accordingly, the image processing apparatus 1 enables the user to easily specify where the failure occurs when the rear camera C3 fails. In the present embodiment, cameras C1 to C4 are exemplary, and the number of cameras such as C1 is not limited to four.

### (Non-Transitory Computer Readable Recording Medium)

A program for enabling computers, other machines and apparatuses (hereinafter be referred to as “computers or other equivalents) to implement any of the functions described above, may be recorded on a non-transitory computer-readable recording medium. The computer or equivalent is made to read and execute the program on the recording medium, thereby enabling the functions to be provided.

Herein, the non-transitory computer-readable medium refer to a recording medium that accumulates (stores) information including data and programs electrically, magnetically, optically, or by chemical action, and is readable by the computer or the equivalent. Among those recording mediums, the recording mediums removable from the computers or the equivalents are flexible discs, magneto-optical disks, CDs (Compact Discs) DVDs (Digital Versatile Discs), Blu-ray discs, and memory cards exemplified by flash memory cards. The recording mediums built in the computers or the equivalents are exemplified by hard disks and ROMs (Read Only Memory). SSDs (Solid State Drives) are usable both as the recording mediums removable from the computers or the equivalents and as the recording mediums built in the computers or the equivalents.

What is claimed is:

1. An image processing apparatus to process view images from a plurality of in-vehicle cameras and output the processed view images to an in-vehicle information processing apparatus having a function of detecting stuck-states of the view images to be input, the image processing apparatus comprising:
controller circuitry configured to instruct the in-vehicle information processing apparatus, when any of the plurality of in-vehicle cameras is determined to be faulty, to disable the stuck-state detection function in a predetermined specific state among a plurality of states defined by combinations of shift lever states of a vehicle and an installation location of the faulty in-vehicle camera.

2. The image processing apparatus according to claim 1, wherein the controller instructs the in-vehicle information processing apparatus to disable the stuck-state detection function when the shift lever of the vehicle is a forward traveling position or a neutral position, and when a failure occurs in a front camera being set to capture a front view image of the vehicle.

3. The image processing apparatus according to claim 1, wherein the controller circuitry instructs the in-vehicle information processing apparatus to disable the stuck-state detection function when the shift lever of the vehicle is a backward traveling position, and when the failure occurs in a rear camera being set to capture a rear view image of the vehicle.

4. An information processing system comprising:
an in-vehicle information processing apparatus having a function of detecting stuck-states of view images; and
an image processing apparatus to process view images from a plurality of in-vehicle cameras and output the processed view images to the in-vehicle information processing apparatus,
the image processing apparatus including controller circuitry to instruct the in-vehicle information processing apparatus, when any of the plurality of in-vehicle cameras is determined to be faulty, to disable the stuck-state detection function in a predetermined specific state among a plurality of states defined by combinations of shift lever states of a vehicle and an installation location of the faulty in-vehicle camera.

5. An information processing method comprising:
processing by an image processing apparatus, view images from a plurality of in-vehicle cameras and outputting the processed view images to an in-vehicle information processing apparatus having a function of detecting stuck-states of view images to be input; and
instructing by the image processing apparatus, the in-vehicle information processing apparatus, when any of the plurality of in-vehicle cameras is determined to be faulty, to disable the stuck-state detection function in a predetermined specific state among a plurality of states defined by combinations of shift lever states of a vehicle and an installation location of the faulty in-vehicle camera.

6. A computer readable non-transitory recording medium storing a program comprising:
processing by an image processing apparatus, view images from a plurality of in-vehicle cameras and outputting the processed view images to an in-vehicle information processing apparatus having a function of detecting stuck-states of view images to be input; and
instructing by the image processing apparatus, the in-vehicle information processing apparatus, when any of the plurality of in-vehicle cameras is determined to be faulty, to disable the stuck-state detection function in a predetermined specific state among a plurality of states defined by combinations of shift lever states of a vehicle and an installation location of the faulty in-vehicle camera.
